(19) United States
(12) Patent Application Publication
(10) Pub. No.: US 2025/0209096 A1
(43) Pub. Date: Jun. 26, 2025

(54) WORK INTRODUCTION INFORMATION GENERATION SUPPORT DEVICE AND CONTROL METHOD THEREFOR

(71) Applicant: Toshiba Tec Kabushiki Kaisha, Tokyo (JP)

(72) Inventor: Daisuke NISHIOKA, Mishima Shizuoka (JP)

(21) Appl. No.: 18/889,918

(22) Filed: Sep. 19, 2024

(30) Foreign Application Priority Data
Dec. 22, 2023 (JP) 2023-217107

(51) Int. Cl. G06F 16/332

(52) U.S. Cl. CPC G06F 16/3326; G06F 16/3329

(57) ABSTRACT

According to an embodiment, a work introduction information generation support device customizes prompt information for requesting generation of work introduction information related to a work to make the prompt information suitable for a customer on the basis of received viewing request information and acquired customer information. Further, the work introduction information generation support device provides the customized prompt information to a large language model.

### CROSS-REFERENCE TO RELATED APPLICATIONS

This application is based upon and claims the benefit of priority from the prior Japanese Patent Application No. 2023-217107, filed on Dec. 22, 2023, the entire contents of which are incorporated herein by reference.

### FIELD

An embodiment described herein generally relates to a work introduction information generation support device and a control method therefor.

### BACKGROUND

Conventionally, there have been terminals that display information related to works to be purchased, rented, or viewed and introduce such works, for example, in stores selling music compact disks (CDs) and movie digital versatile discs (DVDs), rental stores for music CDs and movie DVDs, movie theaters, bookstores and art stores selling books and paintings, libraries, art galleries, museums, or Internet stores offering music, movies, books, paintings, illustrations, and other works via the Internet (hereinafter collectively referred to as “stores, etc.”). Such a terminal may be a dedicated terminal installed in the store, etc., a portable terminal carried by a customer, or a television (TV) set owned by a customer (dedicated terminal, portable terminal, TV, etc. are collectively referred to as “interface”). The customer can operate the interface to view work introduction information of a desired work.

However, the conventional technologies have provided predetermined work introduction information that indicates the contents and characteristics of a work, making it difficult to provide work introduction information that reflects the tastes and interests of each customer. Therefore, there have been limitations in attracting the interests of customers and differentiating the work introduction information from that of other works.

### BRIEF DESCRIPTION OF THE DRAWINGS

FIG. 1 is an overall system diagram including a system according to an embodiment.

FIG. 2 is a sequence diagram showing the processing and data flow between devices.

FIG. 3 is a block diagram showing a hardware configuration of a portable terminal.

FIG. 4 is a block diagram showing a hardware configuration of a customer server.

FIG. 5 is a memory map showing a memory configuration of a customer information section.

FIG. 6 is a memory map showing a memory configuration of a viewing history section.

FIG. 7 is a memory map showing a memory configuration of a preference information section.

FIG. 8 is a block diagram showing a hardware configuration of a prompt generator.

FIG. 9 is a memory map showing a memory configuration of a customer information section.

FIG. 10 is a memory map showing a memory configuration of a canned text information section.

FIG. 11 is a block diagram showing a hardware configuration of a processing server.

FIG. 12 is a flowchart showing a control processing flow of the portable terminal.

FIG. 13 is a functional block diagram showing a functional configuration of the prompt generator.

FIG. 14 is a flowchart showing a control processing flow of the prompt generator.

FIG. 15 is a flowchart showing a control processing flow of the processing server.

### DETAILED DESCRIPTION

According to one embodiment, a work introduction information generation support device includes a communication device, a memory, and a processor. The communication device communicates with a portable terminal of a customer and a customer server, and inputs viewing request information of a work from the portable terminal and inputs customer information from the customer server. The viewing request information includes customer identification information for identifying a customer and work identification information for identifying a work to be viewed. The customer server stores the customer information in association with the customer identification information, the customer information being information of the customer identified by the customer identification information. The memory stores a program for supporting generation of work introduction information related to the work. By executing the program, the processor receives the viewing request information input by the communication device. Further, the processor acquires the customer information input by the communication device on the basis of the customer identification information included in the received viewing request information. Further, the processor customizes prompt information for requesting the generation of the work introduction information to make the prompt information suitable for the customer on the basis of the received viewing request information and the acquired customer information. Furthermore, the processor provides the customized prompt information to a large language model.

One embodiment of the invention will be described in detail below with reference to the drawings. In the drawings, identical symbols indicate identical or similar parts. The embodiment describes a prompt generator as an example of a work introduction information generation support device. The embodiment also describes a portable terminal carried by a customer as an example of an interface. The embodiment also describes a rental store that rents compact disks (CDs), video cassettes, digital versatile discs (DVDs), Blu-ray discs, etc. (hereinafter, collectively referred to as “media”) as an example of a store. A CD is, for example, a disk on which music is recorded. A DVD is a disc on which movies and music are recorded. Hereafter, information (e.g., movies, music, etc.) recorded on a CD, a videocassette, a DVD, or a Blu-ray disc will be referred to as a work. Note that, in the following description, information in a broader sense including movies and music (including paintings, books, art, etc.) may be referred to as a work. The invention is not limited by the embodiment to be described below.

A rental store displays a large number of media therein. The rental store rents, to customers, the media related to works the customers wish to watch or listen to. When a customer becomes a member of the rental store, the customer can specify the work the customer wants to watch by using an online platform from a portable terminal carried by the customer (e.g., smartphone, personal digital assistant (PDA), tablet terminal, etc.), and causes the portable terminal to display work introduction information of the work to be rented or the work that the customer is interested in, so that the customer can confirm in advance whether or not the customer really wants to rent that work. Since the displayed work introduction information is information including work information that introduces the contents of the work as well as including the tastes and preferences of the customer, the customer can view work introduction information to attract more interest in renting that work and to arouse his/her desire to purchase that work.

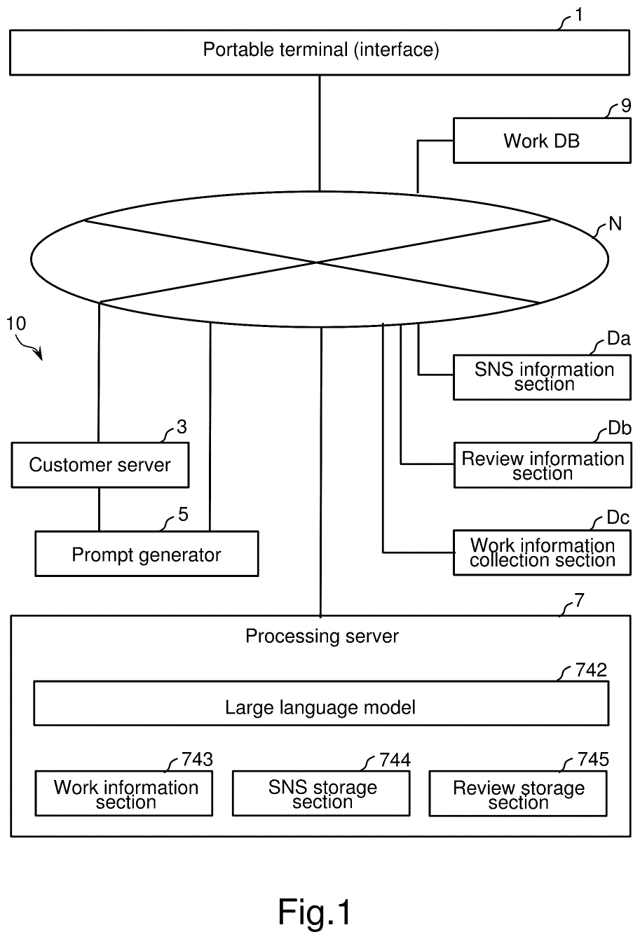

FIG. 1 is a diagram of the overall system configuration including a system 10 according to an embodiment. The system 10 includes at least a portable terminal 1 and a prompt generator 5. In the embodiment, the system 10 includes the portable terminal 1, a customer server 3, and the prompt generator 5. The portable terminal 1, the customer server 3, and the prompt generator 5 are connected to each other and can communicate with each other via a network N such as an Internet line, for example, and can mutually transmit and receive information. A processing server 7 equipped with a large language model 742 is also connected to the network N.

The portable terminal 1 is an example of an interface and is, for example, a terminal that can be carried by a customer, such as a smartphone, a PDA, or a tablet terminal. The portable terminal 1 includes application software installed thereon. Using the application software, the portable terminal 1 inputs, to the customer server 3, attribute information (age, gender, viewing history of works, etc.) of a customer who has become a member as well as customer's information on tastes and preferred works. In addition, the portable terminal 1 connects to the prompt generator 5 using the application software, specifies the work the customer wishes to view, and creates viewing request information that includes work identification information for identifying the work. The portable terminal 1 transmits the created viewing request information to the prompt generator 5.

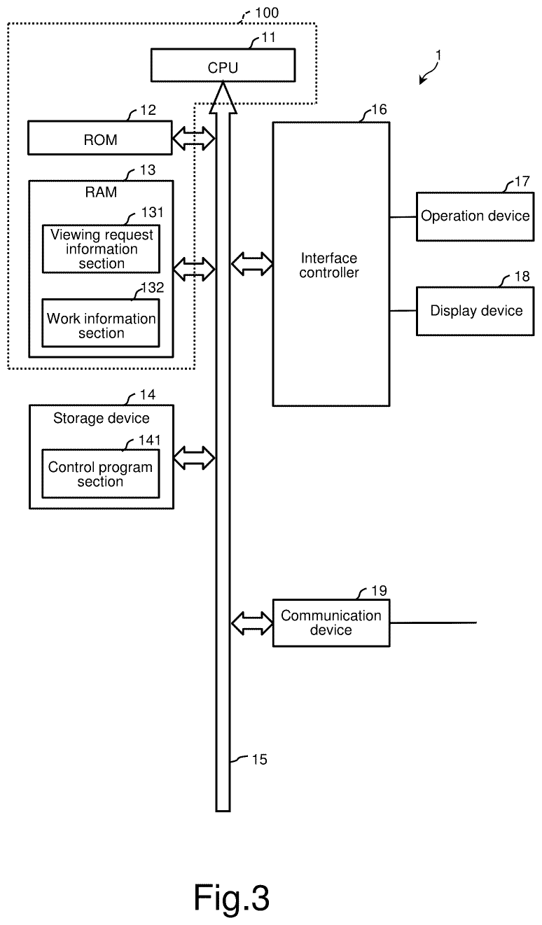

The portable terminal 1 also receives the work introduction information for introducing the specified work from the prompt generator 5. The portable terminal 1 displays the received work introduction information on a display device 18 (see FIG. 3). By viewing the displayed work introduction information, the customer recognizes the contents of the work and its relationship to the customer's tastes and preferences.

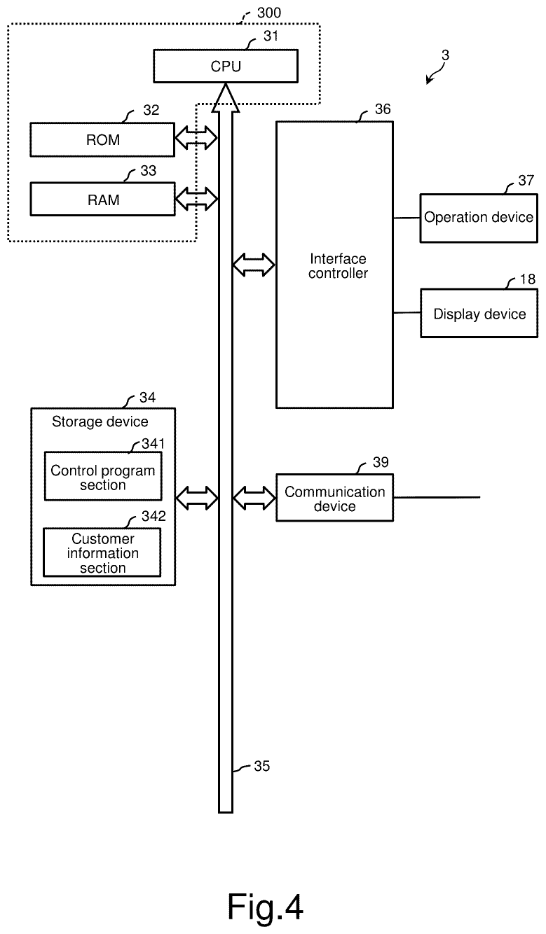

The customer server 3 is an example of a customer database that is installed in the backyard of the rental store, for example. The customer server 3 stores various types of customer information related to each customer (attribute information of the customer, viewing history information of works that the customer has viewed previously, information on tastes and preferences of the customer, etc.). The customer server 3 will be described later with reference to FIGS. 4 to 7. Note that the customer server 3 may be installed at the headquarter of the rental store, or the customer server 3 may be a cloud server installed in the cloud.

When receiving the viewing request information related to the work specified by the customer from the portable terminal 1, the prompt generator 5 acquires the customer information of the customer from the customer server 3.

The prompt generator 5 customizes, for the customer, the prompt information of the specified work related to the customer with reference to the acquired customer information, and generates prompt information (including the customer information of the customer) suitable for the customer. The prompt information is information that requests the processing server 7 to generate work introduction information related to the work. The customized prompt information includes the customer information of the customer. The prompt generator 5 then provides (transmits) the customized prompt information to the processing server 7. In other words, the prompt generator 5 requests the processing server 7 to generate work introduction information on the basis of the customized prompt information. The prompt generator 5 also receives the work introduction information generated by the processing server 7 and transmits it to the portable terminal 1 that has transmitted the viewing request information.

The processing server 7 is a server located outside of the system 10 (e.g., built by an outside company). The processing server 7 includes the large language model 742. The large language model 742 is a language model (program) built using a very large data set and the deep learning technology. Compared to conventional natural language models, the large language model 742 is built with significantly increased “amount of computation”, “amount of data”, and “amount of parameters”. The large language model 742 is a general-purpose model that enables communication with human-like fluency and that can perform various types of processing (e.g., content recognition, translation, prediction, and generation) using natural languages with high accuracy, and is a known technology. The large language model 742 is described, for example, in “A Survey of Large Language Models—How to Build Large Language Model (LLM), Megatron-DeepSpeed Edition Part 1 (zenn.dev)”.

A work database (DB) 9 is connected to the network N. The work DB 9 stores, for each work, various types of work information (genre of work, actor, director, summary of contents, setting of characters, theme of work, subtitle data, etc.) related to the works rented at the rental store. The processing server 7 collects the work information stored in the work DB 9 for each work and stores the work information in a work information section 743.

A social networking service (SNS) information section Da and a review information section Db are also connected to the network N. The SNS information section Da stores information related to the works (e. g., review information and SNS information posted on the SNS). The review information section Db stores work evaluation information (age of evaluator, gender of evaluator, and contents of evaluation) posted on a review site. The processing server 7 collects the SNS information stored in the SNS information section Da and collects the work evaluation information stored in the review information section Db. The processing server 7 collects, for example, information on evaluations of works by respective age groups from the work evaluation information and the SNS information. The SNS information is information such as “30s, male, recommended to watch with family” or “30s, male, found something different from when he was a child”.

Further, a work information collection section Dc is also connected to the network N. The work information collection section Dc collects the work information from the work DB 9, the SNS information from the SNS information section Da, and the work evaluation information from the review information section Db. The processing server collects the work information, the SNS information, and the work evaluation information from the work information collection section Dc. The processing server 7 stores the collected work information in the work information section 743, stores the collected SNS information in an SNS storage section 744, and stores the collected work evaluation information in a review storage section 745.

The processing server 7 trains the large language model 742 on the basis of the collected information. The large language model 742 is trained by collecting many pieces of work information, SNS information, and work evaluation information. The processing server 7 trains the large language model 742 on the basis of the collected work information, thus enriching the work introduction information to be generated. Further, the processing server 7 trains the large language model 742 on the basis of the collected work evaluation information, thus enriching the background information for generating work introduction information corresponding to the customer. Furthermore, the processing server 7 trains the large language model 742 on the basis of the collected SNS information and review information, thus enriching the background information for generating work introduction information, such as words and comments used to introduce a work.

The processing server 7 generates work introduction information related to a work on the basis of the prompt information received from the prompt generator 5. The processing server 7 generates work introduction information suitable for the customer (customized for the customer so as to fully reflect the tastes and preferences or interests of the customer) on the basis of the customer information included in the received prompt information. The work introduction information suitable for each customer can increase the level of satisfaction of that customer. Further, for customers who are considering purchasing or renting works, the work introduction information can increase their willingness to purchase or rent the works. The processing server 7 transmits the generated work introduction information to the prompt generator 5.

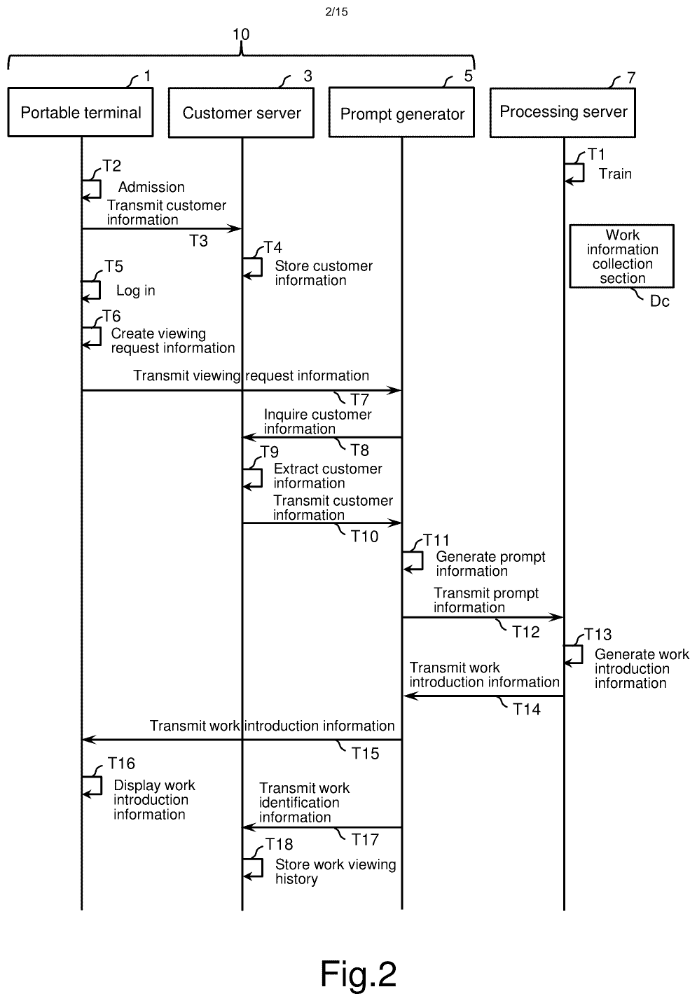

In the following, the processing and data flow between the portable terminal 1, the customer server 3, the prompt generator 5, and the processing server 7 will be described. FIG. 2 is a sequence diagram showing the processing and data flow between the portable terminal 1, the customer server 3, the prompt generator 5, and the processing server 7.

As shown in FIG. 2, the processing server 7 collects the work information, the SNS information, and the work evaluation information from the work information collection section Dc and trains the large language model 742 (T1).

The portable terminal 1 accesses the website of the rental store and goes through an admission registration procedure to become a member of the rental store (T2). The rental store issues a customer identification (ID: customer identification information) for identifying the customer to the customer who carries the portable terminal 1 used for the admission registration. The portable terminal 1 installs application software during the admission registration procedure. Once the application software is installed on the portable terminal 1, the portable terminal 1 can perform an operation such as inputting customer information or transmitting viewing requests for works. In addition, the portable terminal 1 on which the application software has been installed can display work introduction information received from the prompt generator 5. The portable terminal 1 inputs customer information during the admission procedure and transmits the customer information together with the issued customer ID to the customer server 3 (T3). The customer server 3 stores the customer information received from the portable terminal 1 in association with the customer ID received at the same time (T4). Note that the customer information and customer ID of the customer may be transmitted to the customer server 3 (processing in T3) from a terminal of the rental store for which the admission registration has been performed.

When the customer views a work, the customer logs in to the portable terminal 1 (T5). By the customer's operation, the portable terminal 1 then creates viewing request information including work identification information (work ID or name of work) for identifying a work to be viewed and the customer ID (T6). The portable terminal 1 then transmits the created viewing request information to the prompt generator 5 by the customer's operation (T7).

The prompt generator 5 transmits the customer ID, which is included in the received viewing request information, to the customer server 3 (T8). In other words, the prompt generator 5 inquires the customer information of the customer from the customer server 3 (T8). The customer server 3 extracts the customer information of the customer on the basis of the received customer ID (T9). The customer server 3 then transmits the extracted customer information to the prompt generator 5 (T10). The prompt generator 5 calls a canned text of the prompt information related to the work on the basis of the work identification information received from the portable terminal 1, and generates prompt information suitable for the customer (i.e., customizes prompt information for the customer), which reflects the received customer information in the canned text (T11). The prompt generator 5 then transmits (provides) the generated prompt information for that customer to the processing server 7 via the network N (T12).

On the basis of the received prompt information for that customer, the processing server 7 generates work introduction information suitable for that customer using the large language model 742 (T13). The processing server 7 then transmits the generated work introduction information to the prompt generator 5 (T14).

The prompt generator 5, which has received the work introduction information, transmits (outputs) the work introduction information to the portable terminal 1 (T15). The portable terminal 1 displays the received work introduction information on the display device 18 (T16). The customer can view the displayed work introduction information suitable for the customer.

The prompt generator 5 also transmits the work identification information included in the received work introduction information, together with the customer ID, to the customer server 3 (T17). On the basis of the received customer ID and work identification information, the customer server 3 adds the viewing information of the work identified by the work identification information to the viewing information already stored and stores it in the viewing history of the customer (T18).

The hardware configuration of the portable terminal 1 will now be described. FIG. 3 is a block diagram showing the hardware configuration of the portable terminal 1. As shown in FIG. 3, the portable terminal 1 includes a central processing unit (CPU) 11, which is an example of a processor, a read only memory (ROM) 12, a random access memory (RAM) 13, a storage device 14, and the like. The CPU 11 is a control entity. The ROM 12 stores various programs. The RAM 13 expands programs and various types of data. The storage device 14 stores various programs. The CPU 11, the ROM 12, the RAM 13, and the storage device 14 are connected to each other via a bus 15. The CPU 11, the ROM 12, and the RAM 13 constitute a controller 100. In other words, the controller 100 executes control processing related to the portable terminal 1, which will be described later, by the CPU 11 operating according to the control programs that are stored in the ROM 12 and the storage device 14 and expanded in the RAM 13.

The RAM 13 includes a viewing request information section 131 and a work information section 132. The viewing request information section 131 stores the viewing request information for requesting work introduction information of the work, which has been created by the customer. The work information section 132 receives from the prompt generator 5 the work introduction information generated by the processing server 7 on the basis of the transmitted viewing request information, and stores the work introduction information therein.

The storage device 14 includes a non-volatile memory such as a hard disk drive (HDD) or flash memory that retains the stored information even when the power is turned off. The storage device 14 includes a control program section 141. The control program section 141 stores control programs for controlling the portable terminal 1. The installed application software is stored in the control program section 141.

Further, the controller 100 is connected to an operation device 17 and the display device 18 via the bus 15 and an interface controller 16. The operation device 17 is a keyboard. The display device 18 displays information to an operator who operates the portable terminal 1. Note that the operation device 17 may be a touch panel provided on the display device 18.

Further, the controller 100 is connected to a communication device 19 via the bus 15. The communication device 19 is communicatively connected to the prompt generator 5 via the network N and is capable of transmitting and receiving information.

Next, the hardware configuration of the customer server 3 will be described. FIG. 4 is a block diagram showing the hardware configuration of the customer server 3. As shown in FIG. 4, the customer server 3 includes a CPU 31, which is an example of a processor, a ROM 32, a RAM 33, a storage device 34, and the like. The CPU 31 is a control entity. The ROM 32 stores various programs. The RAM 33 expands programs and various types of data. The storage device 34 stores various programs. The CPU 31, the ROM 32, the RAM 33, and the storage device 34 are connected to each other via a bus 35. The CPU 31, the ROM 32, and the RAM 33 constitute a controller 300. In other words, the controller 300 executes control processing related to the customer server 3 by the CPU 31 operating according to the control programs that are stored in the ROM 32 and the storage device 34 and expanded in the RAM 33.

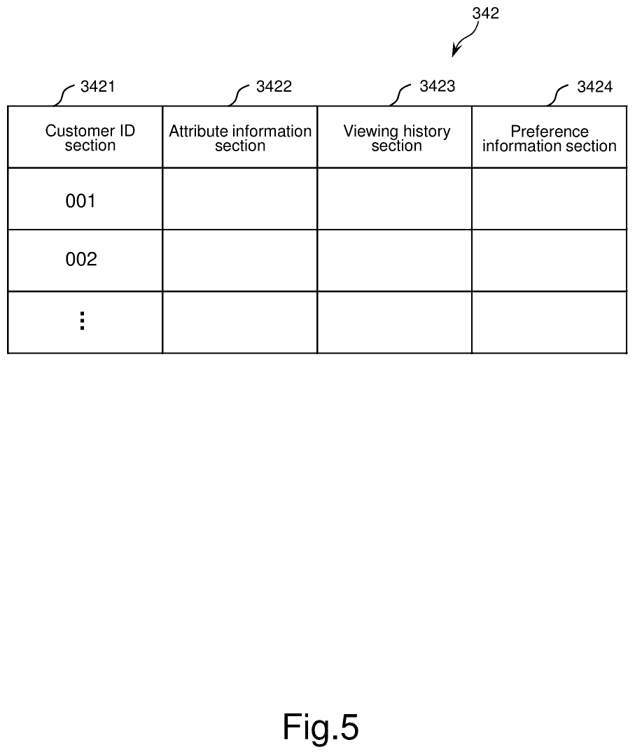

The storage device 34 includes a non-volatile memory such as an HDD or flash memory that retains the stored information even when the power is turned off. The storage device 34 includes a control program section 341, a customer information section 342, and the like. The control program section 341 stores control programs for controlling the customer server 3. The customer information section 342 stores customer information related to customers who have become members of the rental store. The customer information section 342 will be described later with reference to FIGS. 5 to 7.

Further, the controller 300 is connected to an operation device 37 and a display device 38 via the bus 35 and an interface controller 36. The operation device 37 is a keyboard. The display device 38 displays information to an operator who operates the customer server 3.

Further, the controller 300 is connected to a communication device 39 via the bus 35. The communication device 39 is communicatively connected to the portable terminal 1 via the network N and is capable of transmitting and receiving information. Further, the communication device 39 is also connected to the prompt generator 5 via a communication line and is capable of transmitting and receiving information.

Next, the customer information section 342 will be described. FIG. 5 is a memory map showing the memory configuration of the customer information section 342. As shown in FIG. 5, the customer information section 342 stores customer information of each customer for each customer ID issued to the customer who has become a member. The customer information section 342 includes a customer ID section 3421, an attribute information section 3422, a viewing history section 3423, and a preference information section 3424. The customer ID section 3421 stores, for each customer, a customer ID for identifying a customer who has been a member. The attribute information section 3422 stores attribute information of the customer (gender, age, age group, address, telephone number, address of portable terminal 1, etc.) as customer information in association with the customer ID stored in the customer ID section 3421.

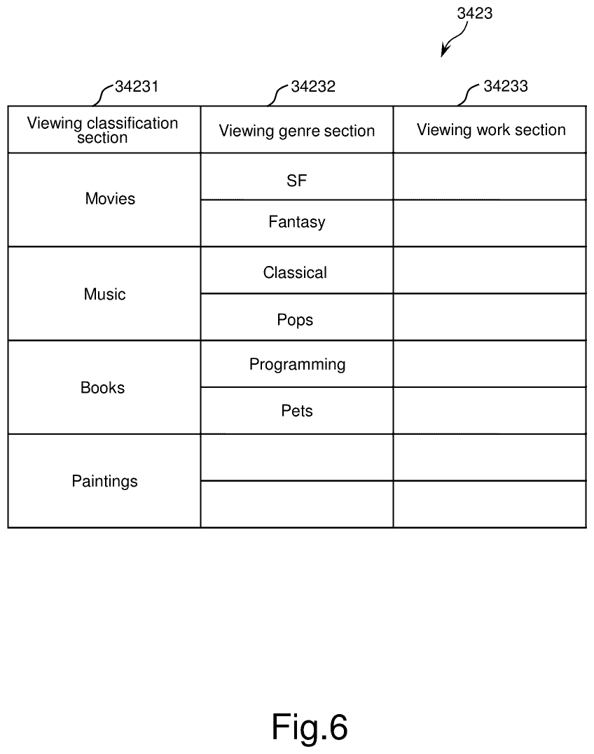

The viewing history section 3423 stores information (name of work, work identification information for identifying the work, date of viewing, etc.) of the works previously viewed or appreciated (hereinafter, typically referred to as “viewed”) by the customer, as customer information for each genre of works, in association with the customer ID stored in the customer ID section 3421. FIG. 6 shows the viewing history section 3423 in detail. FIG. 6 is a memory map showing the memory configuration of the viewing history section 3423. Note that FIG. 6 shows the information of the viewing history section 3423 related to one customer, but the viewing history section 3423 actually stores information corresponding to the number of customer IDs.

As shown in FIG. 6, the viewing history section 3423 includes a viewing classification section 34231, a viewing genre section 34232, and a viewing work section 34233. The viewing classification section 34231 stores the classifications of works previously viewed by the customer. In the embodiment, for example, the works are classified into movies, music, books, and paintings. The viewing genre section 34232 stores the genres of works for the works belonging to each classification. In the embodiment, the works of movies previously viewed by the customer are classified into science fiction (SF) and fantasy genres. Similarly, the genres of music that the customer has listened to previously are classified into classical and pops. Books and paintings are also classified by genre similarly. The viewing work section 34233 stores, in association with the genres stored in the viewing genre section 34232, information of the works belonging to those genres and previously viewed by the customer (name of work, work identification information for identifying the work, date of viewing, etc.). In other words, the viewing history section 3423 stores the information of the works previously viewed by the customer, which are classified by category and genre.

Note that the viewing history section 3423 stores, in addition to the information on the works previously viewed by the customer, information on works previously viewed related to other facilities such as bookstores, libraries, movie theaters, museums, art galleries, etc. The information on works related to other facilities can be input by the customer from the portable terminal 1. Further, if a common customer ID is assigned among facilities, or the customer IDs at respective facilities are mutually associated, the information on works viewed at respective facilities may be collected on the basis of the customer IDs.

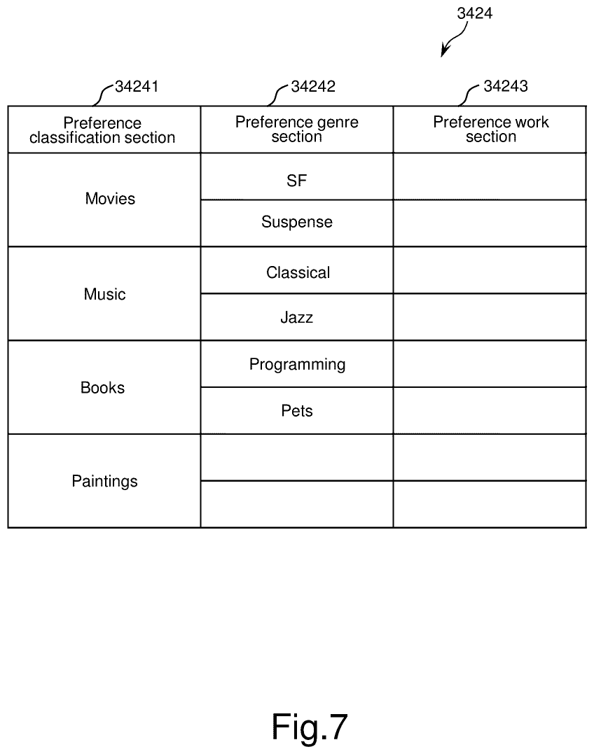

The preference information section 3424 stores information related to the tastes, preferences, and interests of the customer as customer information for each customer ID, in association with the customer ID stored in the customer ID section 3421. FIG. 7 shows the preference information section 3424 in detail. Note that FIG. 7 shows the information of the preference information section 3424 related to one customer, but the preference information section 3424 actually stores information corresponding to the number of customer IDs.

FIG. 7 is a memory map showing the memory configuration of the preference information section 3424. As shown in FIG. 7, the preference information section 3424 includes a preference classification section 34241, a preference genre section 34242, and a preference work section 34243. The preference classification section 34241 stores the classifications of works preferred by the customer. In the embodiment, for example, the works are classified into movies, music, books, and paintings. The preference genre section 34242 stores the genres of works for the works belonging to each classification. In the embodiment, movie works preferred by the customer are classified into SF and suspense genres. Similarly, the genres of music preferred by the customer are classified into classical and jazz. Books and paintings are also classified by genre similarly. The preference work section 34243 stores, in association with the genres stored in the preference genre section 34242, information of the works belonging to those genres (name of work, work identification information for identifying the work, etc.). In other words, the preference information section 3424 stores the information of the works preferred by the customer, which are classified by category and genre. The preference genre section 34242 may store information of genres of other works appearing in the works stored in the viewing work section 34233.

Note that the preference information section 3424 stores, in addition to the information of the works preferred by the customer in the rental store, information on works preferred by the customer in other facilities such as bookstores, libraries, movie theaters, museums, art galleries, etc. The preference information section 3424 may store information on other works appearing in the works stored in the viewing work section 34233. The information on works viewed at other facilities can be input by the customer from the portable terminal 1. Further, if a common customer ID is assigned among facilities, or the customer IDs at the respective facilities are mutually associated, the information on works viewed at respective facilities may be collected on the basis of the customer IDs.

Note that the customer information to be stored in the attribute information section 3422, the viewing history section 3423, and the preference information section 3424 can be input from the portable terminal 1 when the customer is registered for membership, and can also be additionally input in a timely manner after registration n for membership. Further, information on works viewed by the customer are additionally stored in the viewing history section 3423 each time.

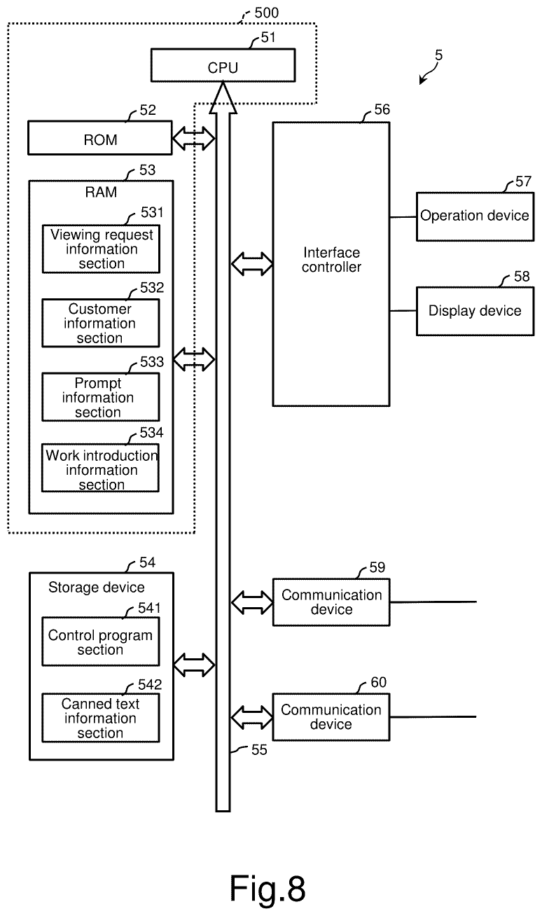

Next, the hardware configuration of the prompt generator 5 will be described. FIG. 8 is a block diagram showing the hardware configuration of the prompt generator 5. As shown in FIG. 8, the prompt generator 5 includes a CPU 51, which is an example of a processor, a ROM 52, a RAM 53, a storage device 54, and the like. The CPU 51 is a control entity. The ROM 52 stores various programs. The RAM 53 expands programs and various types of data. The storage device 54 stores various programs. The CPU 51, the ROM 52, the RAM 53, and the storage device 54 are connected to each other via a bus 55. The CPU 51, the ROM 52, and the RAM 53 constitute a controller 500. In other words, the controller 500 executes control processing related to the prompt generator 5, which will be described later, by the CPU 51 operating according to the control programs that are stored in the ROM 52 and the storage device 54 and expanded in the RAM 53.

The RAM 53 includes a viewing request section 531, a customer information section 532, a prompt information section 533, and a work introduction information section 534. The viewing request section 531 stores the viewing request information of a work that the customer wishes to view, which has been received from the portable terminal 1. The viewing request section 531 stores the viewing request information including work identification information for identifying a work, such as “Please give me information about a work XX.”, information for requesting viewing, and a customer ID for identifying the customer.

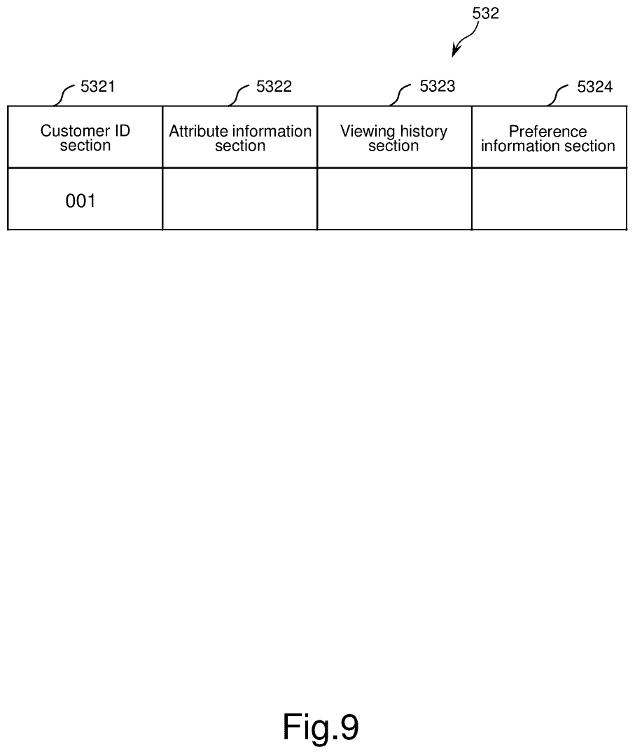

The customer information section 532 stores the customer information of the customer that has been received from the customer server 3, on the basis of the customer ID included in the viewing request information. The customer information section 532 will be described later with reference to FIG. 9. The prompt information section 533 stores prompt information that is customized for the customer by reflecting the customer information stored in the customer information section 532 in the prompt information related to the work, which is called from a canned text information section 542, on the basis of the received viewing request information. The canned text information section 542 will be described later. The work introduction information section 534 receives and stores the work introduction information generated by the processing server 7 on the basis of the customized prompt information.

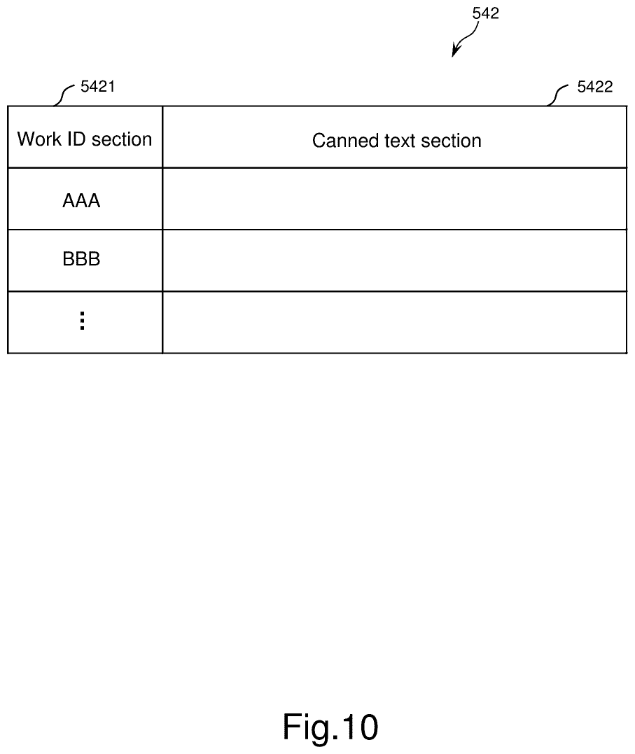

The storage device 54 includes a non-volatile memory such as an HDD or flash memory that retains the stored information even when the power is turned off. The storage device 54 includes a control program section 541 and the canned text information section 542. The control program section 541 stores control programs for controlling the prompt generator 5. The canned text information section 542 stores prompt information to be transmitted to the processing server 7 for each work. The prompt information stored in the canned text information section 542 is a canned text for requesting generation of work introduction information of a work, which is commonly prepared for each work before the customer information is reflected. Note that the prompt information stored in the canned text information section 542 may be the prompt information common to all works or may be the prompt information prepared for each genre of works. The canned text information section 542 will be described later with reference to FIG. 10.

Further, the controller 500 is connected to an operation device 57 and a display device 58 via the bus 55 and an interface controller 56. The operation device 57 is a keyboard. The display device 58 displays information to an operator who operates the prompt generator 5.

Further, the controller 500 is connected to a communication device 59 and a communication device 60 via the bus 55. The communication device 59 is communicatively connected to the portable terminal 1 and the processing server 7 via the network N and is capable of transmitting and receiving information. Further, the communication device 60 is also connected to customer server 3 via a communication line and is capable of transmitting and receiving information.

Next, the customer information section 532 will be described. The customer information section 532 receives, from the customer server 3, the customer information of the customer identified by the customer ID inquired from the customer server 3 and stores the customer information. FIG. 9 is a memory map showing the memory configuration of the customer information section 532. The example in FIG. 9 shows an example in which the customer information of a customer with a customer ID “001” is read out of the customer information of a plurality of customers stored in the customer information section 342 and then stored in the customer information section 532. As shown in FIG. 9, the customer information section 532 includes a customer ID section 5321, an attribute information section 5322, a viewing history section 5323, and a preference information section 5324. The customer ID section 5321 stores the customer ID included in the viewing request information. The attribute information section 5322 stores the attribute information of the customer (gender, age, age group, address, telephone number, address of portable terminal 1, etc.), which is read from the attribute information section 3422 corresponding to the customer ID stored in the customer ID section 5321, as customer information.

The viewing history section 5323 stores the information of the works previously viewed by the customer (name of work, work identification information for identifying the work, date of viewing, etc.), which is read from the viewing history section 3423 corresponding to the customer ID stored in the customer ID section 5321, as customer information for each genre of works. Note that the viewing history section 5323 has a configuration equivalent to that of the viewing history section 3423 related to one customer, details of which are shown in FIG. 6. The viewing history section 5323 shown in FIG. 9 stores information on works previously viewed by the customer, related to the customer with the customer ID “001”.

The preference information section 5324 stores, as customer information, the information related to the tastes, preferences, and interests of the customer, which are read from the preference information section 3424 corresponding to the customer ID stored in the customer ID section 5321. The preference information section 5324 has a configuration equivalent to that of the preference information section 3424 related to one customer, details of which are shown in FIG. 7.

Next, the canned text information section 542 will be described. FIG. 10 is a memory map showing the memory configuration of the canned text information section 542. The canned text information section 542 is a template in which a canned text of prompt information to be transmitted to the processing server 7 is stored for each work. As shown in FIG. 10, the canned text information section 542 includes a work ID section 5421 and a canned text section 5422. The work ID section 5421 stores work IDs that are work identification information for identifying works, for each work. The canned text section 5422 stores the canned text of the prompt information related to the work in association with the work ID stored in the work ID section 5421. For example, for a work A identified by a work ID “AAA”, a canned text such as “Please recommend the work A to people with the following characteristics such that they can find as much relevance as possible: generation XX; gender XX; often preferring works called XX and XX and genres XX; and also preferring music called XX.” is stored. Parameters including various words and the like extracted from the customer information are inserted into XX, so that the prompt information that reflects the customer information in the canned text is generated.

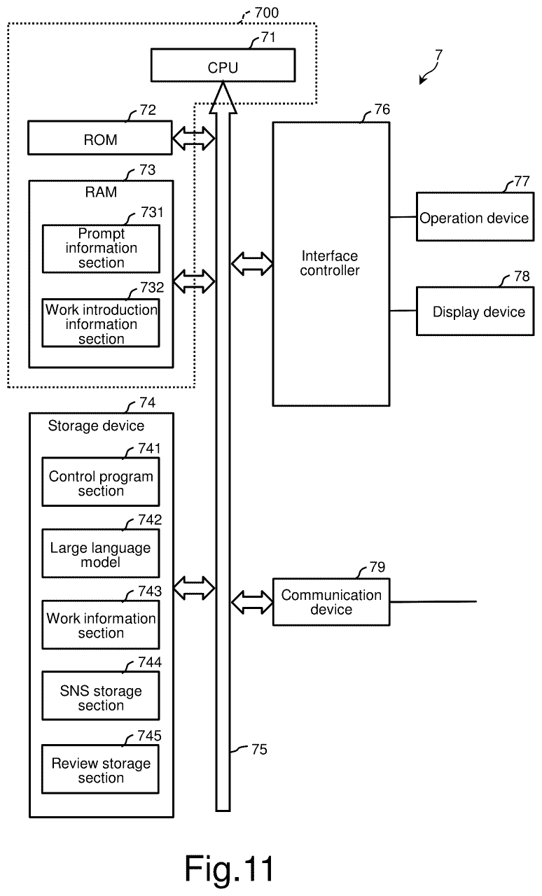

Next, the hardware configuration of the processing server 7 will be described. FIG. 11 is a block diagram showing the hardware configuration of the processing server 7. As shown in FIG. 11, the processing server 7 includes a CPU 71, which is an example of a processor, a ROM 72, a RAM 73, a storage device 74, and the like. The CPU 71 is a control entity. The ROM 72 stores various programs. The RAM 73 expands programs and various types of data. The storage device 74 stores various programs. The CPU 71, the ROM 72, the RAM 73, and the storage device 74 are connected to each other via a bus 75. The CPU 71, the ROM 72, and the RAM 73 constitute a controller 700. In other words, the controller 700 executes control processing related to the processing server 7, which will be described later, by the CPU 71 operating according to the control programs that are stored in the ROM 72 and the storage device 74 and expanded in the RAM 73.

The RAM 73 includes a prompt information section 731 and a work introduction information section 732. The prompt information section 731 stores the prompt information customized for a particular customer, which is received from the prompt generator 5. The work introduction information section 732 stores the work introduction information suitable for that customer, which is generated on the basis of the received prompt information.

The storage device 74 includes a non-volatile memory such as an HDD or flash memory that retains the stored information even when the power is turned off. The storage device 74 includes a control program section 741, a large language model 742, a work information section 743, an SNS storage section 744, and a review storage section 745. The control program section 741 stores control programs for controlling the processing server 7. The large language model 742 is a program for generating work introduction information 4 a work, which reflects the customer information included in the prompt information, on the basis of the received prompt information. The work information section 743 stores the work information collected from the work DB 9 for each work. The SNS storage section 744 stores the SNS information collected from the SNS information section Da. The review storage section 745 stores the work evaluation information collected from the review information section Db.

Further, the controller 700 is connected to an operation device 77 and a display device 78 via the bus 75 and an interface controller 76. The operation device 77 is a keyboard. The display device 78 displays information to an operator who operates the processing server 7.

Further, the controller 700 is connected to the communication device 79 via the bus 75. The communication device 79 is communicatively connected to the prompt generator 5 via the network N and is capable of transmitting and receiving information.

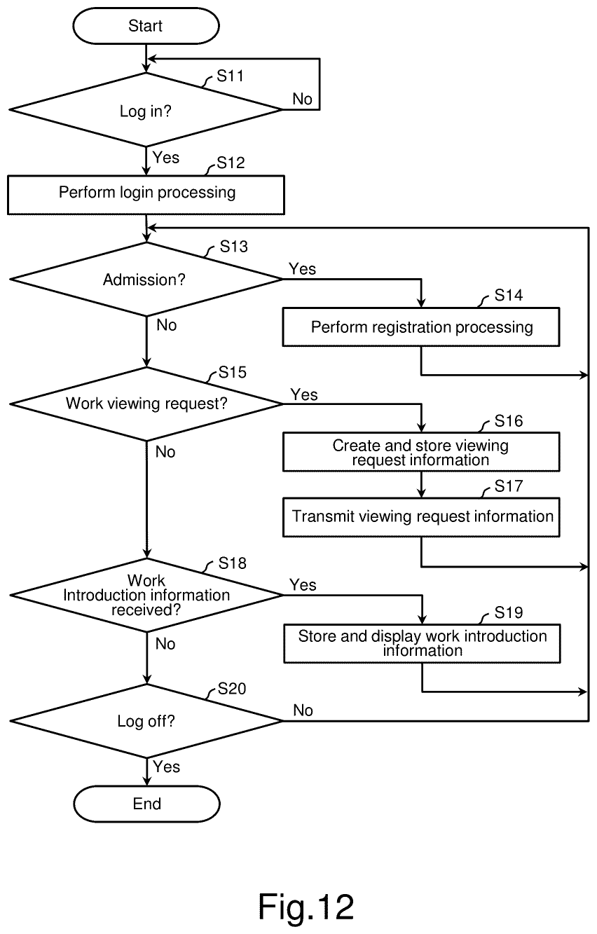

Hereinafter, the control of the portable terminal 1 will be described. FIG. 12 is a flowchart showing a control processing flow of the portable terminal 1. As shown in FIG. 12, the controller 100 of the portable terminal 1 determines whether the portable terminal 1 is logged in to (S11). The controller 100 waits until the portable terminal 1 is logged in to (No in S11), and if it determines that the portable terminal 1 is logged in to (Yes in S11), the controller 100 performs login processing for the portable terminal 1 (S12). Next, the controller 100 determines whether an admission registration operation is performed in the portable terminal 1 (S13). If the controller 100 determines that an admission registration operation is performed in the portable terminal 1 (Yes in S13), the controller 100 executes registration processing in which information can be transmitted and received to and from the prompt generator 5 by the application software installed on the portable terminal 1 (S14). The controller 100 then returns to S13.

Alternatively, if determining that it is not the admission registration processing (No in S13), the controller 100 determines whether a work viewing request is instructed by the customer's operation on the portable terminal 1 (S15). For example, if the customer inputs information on a work (e.g., name of work or work ID) and operates a viewing request key (not shown), the controller 100 determines that a work viewing request is instructed. If the viewing request key is not operated, the controller 100 determines that a work viewing request is not instructed. If determining that a viewing request is instructed (Yes in S15), the controller 100 creates viewing request information for requesting viewing from the prompt generator 5 (the viewing request information includes the customer ID of the customer who requests viewing and the work identification information of a work to be viewed (which may be a work ID for identifying the work or may be the name of the work)) and stores the viewing request information in the viewing request information section 131 (S16). The controller 100 then transmits the stored viewing request information to the prompt generator 5 (S17). The controller 100 then returns to S13.

Alternatively, if determining that it is not an instruction of a viewing request (No in S15), the controller 100 determines whether the work introduction information is received from the prompt generator 5 as a response to the viewing request information transmitted in S17 (S18). If determining that the work introduction information is received (Yes in S18), the controller 100 stores the received work introduction information in the work information section 132 (S19) and displays the stored work introduction information on the display device 18 (S19). The controller 100 then returns to S13.

Alternatively, if determining that the work introduction information is not received (No in S18), the controller 100 determines whether the portable terminal 1 is logged off (S20). If determining that the portable terminal 1 is not logged off (No in S20), the controller 100 returns to S13. If determining that the portable terminal 1 is logged off (Yes in S20), the controller 100 terminates the processing and returns to S11.

The portable terminal 1 of the embodiment can request viewing of a work, and also receive and display on the display device 18 the work introduction information customized for the customer, which is generated by reflecting the customer information of the customer who has requested viewing, so that the customer can be more interested in the work by viewing the work introduction information displayed on the display device 18.

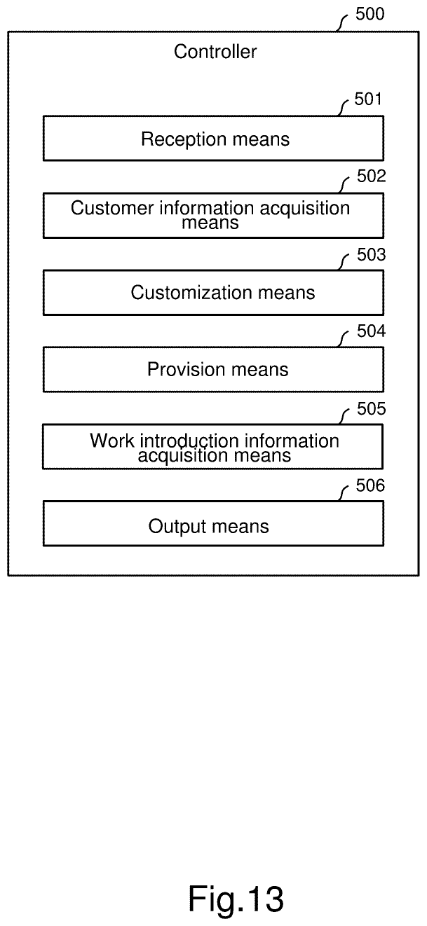

The functional configuration of the prompt generator 5 will now be described. FIG. 13 is a functional block diagram showing the functional configuration of the prompt generator 5. The controller 500 of the prompt generator 5 functions as reception means 501, customer information acquisition means 502, customization means 503, provision means 504, work introduction information acquisition means 505, and output means 506 by following the control programs stored in the ROM 52 and the control program section 541 of the storage device 54.

The reception means 501 receives viewing request information including a customer ID for identifying a customer and work identification information for identifying a work to be viewed.

The customer information acquisition means 502 acquires customer information related to the customer ID on the basis of the received customer ID. Specifically, the customer information acquisition means 502 receives, from the customer server 3, the customer information stored in the customer information section 342 in association with the customer ID on the basis of the customer ID included in the viewing request received from the portable terminal 1, and stores the customer information in the customer information section 532. The customer information to be acquired is attribute information (information stored in the attribute information section 3422), viewing history information (information stored in the viewing history section 3423), and preference information (information stored in the preference information section 3424) of the customer identified by the customer ID. The customer information acquired by the customer information acquisition means 502 includes customer information related to the work that the customer wishes to view and information (various types of information) of works (i.e., multiple types of works) such as works (movies, music, paintings, books) other than the work that the customer wishes to view. For example, the viewing history information acquired by the customer information acquisition means 502 includes information on the works previously viewed by the customer and information on works other than the works previously viewed (e.g., other works or works in other genres that appear in the works previously viewed (if the works are movies, different types of works (music, paintings, books, etc.) other than movies). Further, the preference information acquired by the customer information acquisition means 502 includes information on a plurality of works, i.e., information on the works preferred by the customer and other than those works (e.g., other works or works in other genres that appear in those works (if the works are movies, different types of works (music, paintings, books, etc.) other than movies).

The customization means 503 customizes the prompt information for requesting generation of work introduction information related to the work make the prompt information suitable for the customer on the basis of the received viewing request information and the acquired customer information. Specifically, the customization means 503 inserts the customer information acquired by the customer information acquisition means 502 (past work viewing history information of the customer, information on works preferred by the customer, and information on other works related to those works) into the blanks of the prompt information (canned text) of the work to be viewed, which is extracted from the canned text information section 542 on the basis of the received viewing request information. Thus, the prompt information is customized to suit the customer.

For example, the customization means 503 calls the prompt information (canned text) related to a work A that the customer wishes to view, such as “Please recommend the work A to people with the following characteristics such that they can find as much relevance as possible: generation XX; gender XX; often preferring works called XX and XX and genres XX; and also preferring music called XX.”, from the canned text information section 542. The customization means 503 then inserts the parameters extracted on the basis of the customer information acquired by the customer information acquisition means 502 into XX (blank parts with no information).

For example, if the information of “30s, male” is stored in the attribute information section 5322 as customer information of the customer with the customer ID “001”, the information of “work B” is stored in the viewing history section 5323, and the information of “SF” and “classical” is stored in the preference information section 5324, the controller 500 of the prompt generator 5 extracts “30s”, “male”, “work B”, “SF”, “classical”, etc. as parameters, and inserts those parameters into the XX parts of the above-mentioned canned text, and thus customizes the prompt information that reflects the customer information in the canned text, such as “Please recommend the work A to people with the following characteristics such that they can find as much relevance as possible: 30s; male; often preferring the work B and the genre of SF; and also preferring classical music.”

The provision means 504 provides the prompt information customized by the customization means 503 to the large language model 742. Specifically, the provision means 504 transmits the prompt information customized by the customization means 503 to the processing server 7 including the large language model 742.

The work introduction information acquisition means 505 acquires work introduction information generated by the large language model 742 on the basis of the prompt information provided to the large language model 742. Specifically, the work introduction information acquisition means 505 receives from the processing server 7 the work introduction information suitable for the customer, which is generated by the large language model 742 on the basis of the prompt information that has been customized for the customer and transmitted to the processing server 7.

The output means 506 outputs the acquired work introduction information. Specifically, the output means 506 transmits the work introduction information received from the processing server 7 to the portable terminal 1.

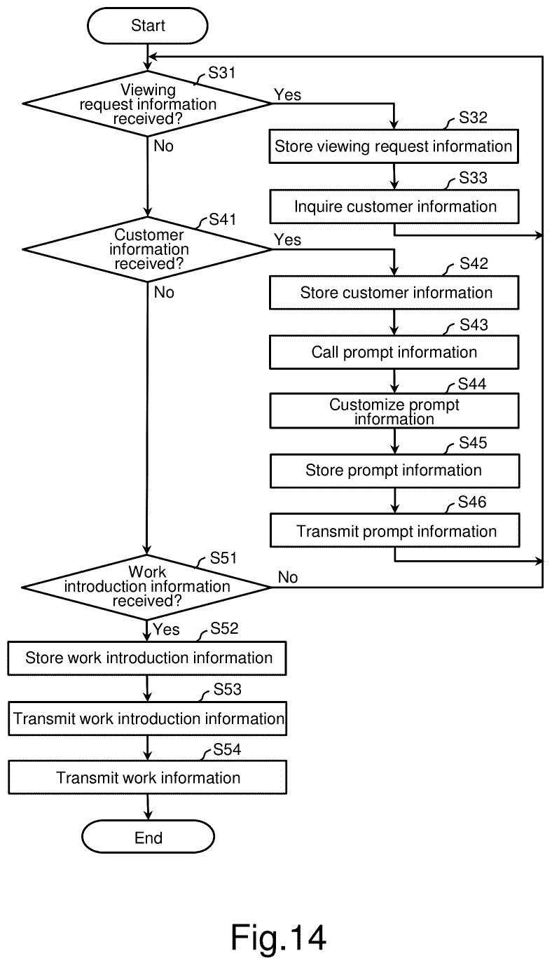

Next, the control of the prompt generator 5 will be described. FIG. 14 is a flowchart showing the control processing flow of the prompt generator 5. The controller 500 of the prompt generator 5 determines whether the viewing request information is received from the portable terminal 1 (S31). If it is determined that the viewing request information is received (Yes in S31), the reception means 501 stores the received viewing request information in the viewing request section 531 (S32). The controller 500 then inquires the customer information of the customer from the customer server 3 on the basis of the customer ID included in the stored viewing request information (S33). The controller 500 then returns to S31.

Alternatively, if it is determined that the viewing request information is not received from the portable terminal 1 (No in S31), the controller 500 determines whether the customer information is received from the customer server 3 as a response to the inquiry of S32 (S41). If it is determined that the customer information is received (Yes in S41), the customer information acquisition means 502 stores the received customer information in the customer information section 532 (S42). Next, the controller 500 searches the canned text information section 542 on the basis of the information of the work (the name of the work or the work ID for identifying the work) included in the stored viewing request information and reads prompt information (canned text) related to the work (S43).

Next, the customization means 503 customizes the prompt information to make the prompt information suitable for the customer of the received customer ID by reflecting the customer information stored in S42 in the read prompt information (canned text) (S44). The controller 500 then stores the customized prompt information in the prompt information section 533 (S45). The provision means 504 then transmits the prompt information stored in the prompt information section 533 to the processing server 7 (S46). The controller 500 then returns to S31.

Alternatively, if it is determined that the customer information is not received (No in S41), the controller 500 determines whether the work introduction information is received from the processing server 7 in response to the transmission in S46 (S51). If it is determined that the work introduction information is not received (No in S51), the controller 500 returns to S31. If it is determined that the work introduction information is received (Yes in S51), the work introduction information acquisition means 505 stores the received work introduction information in the work introduction information section 534 (S52). The output means 506 then transmits the work introduction information stored in the work introduction information section 534 to the portable terminal 1 that has transmitted the viewing request information (S53). The controller 500 then transmits the work information (the name of the work or the work ID) included in the work introduction information stored in the work introduction information section 534, together with the customer ID included in the viewing request information, to the customer server 3 (S54). The controller 300 of the customer server 3 additionally stores the received work information in the viewing history section 3423 associated with the customer ID. In this way, the viewing history of the work is stored as customer information. The controller 500 then terminates the processing.

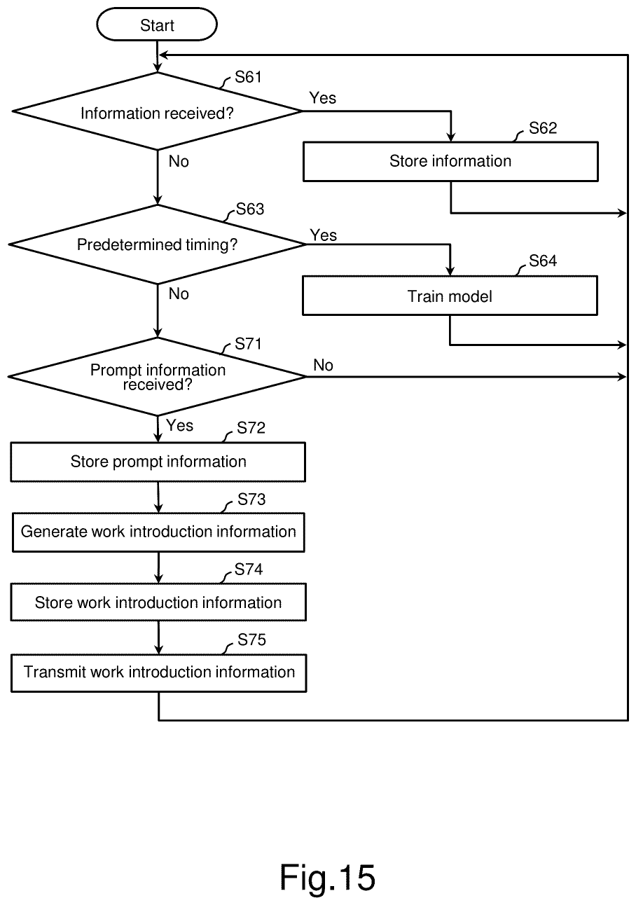

The control of the processing server 7 will now be described. FIG. 15 is a flowchart showing the control processing flow of the processing server 7. As shown in FIG. 15, the controller 700 of the processing server 7 determines whether work information is received from the work DB 9, SNS information from the SNS information section Da, or work evaluation information from the review information section Db (S61). If it is determined that work information is received (Yes in S61), the controller 700 stores the received work information in the work information section 743 (S62). If it is determined that SNS information is received (Yes in S61), the controller 700 stores the received SNS information in the SNS storage section 744 (S62). If it is determined that work evaluation information is received (Yes in S61), the controller 700 stores the received work evaluation information in the review storage section 745 (S62). The controller 700 then returns to S61.

Alternatively, if it is determined that work information, SNS information, or work evaluation information is not received (No in S61), the controller 700 determines whether it is a predetermined timing (S63). The predetermined timing is the timing at which the large language model 742 is trained. If determining that it is a predetermined timing (Yes in S63), the controller 700 trains the large language model 742 on the basis of the work information stored in the work information section 743, the SNS information stored in the SNS storage section 744, and the work evaluation information stored in the review storage section 745 (S64). The controller 700 then returns to S61.

Alternatively, if determining that it is not a predetermined timing (No in S63), the controller 700 determines whether prompt information is received from the prompt generator 5 (S71). If it is determined that the prompt information is not received (No in S71), the controller 700 returns to S61. If it is determined that the prompt information is received (Yes in S71), the controller 700 stores the received prompt information in the prompt information section 731 (S72). The controller 700 then uses the large language model 742 to generate the work introduction information related to the prompt information stored in the prompt information section 731 (S73).

The following is an example of the work introduction information that is generated by the controller 700 using the large language model 742. The work introduction information generated using the large language model 742 differs depending on the contents of the prompt information received. For example, if the prompt information is simply a request to introduce a work A and does not reflect any customer information, the controller 700 generates work introduction information indicating the contents and characteristics of the work A, such as “The work A is a fairy tale written by the Italian author A in 1883.The story describes the adventures of a boy, a wooden doll, to become a human being. The boy is initially unable to speak, and has a trait that makes his nose grow longer each time he tells a lie. The story follows the boy as he learns the importance of honesty, courage, and friendship in the face of many challenges. This work A not only conveys the lesson of integrity to children, but also contains elements of adventure and fantasy. This work A is well known and loved throughout the world.”

Further, if prompt the information received reflects the customer information (e.g., parameters such as “30s”, “male”, “work B”, “SE”, “classical”, etc.), the controller 700 generates attractive work introduction information that will attract the interest of a customer by reflecting the customer information of the customer who will view the work, in addition to the contents and characteristics of the work A, such as “The work A is one of the most special animated films and can be enjoyed regardless of age or gender. The work A is a magical story about a doll born from a tree that magically transforms into a real-life boy. The film is a bit different from science fiction, but as it depicts adventures in a fantasy world, science fiction lovers may also enjoy the fantastical world. It also includes classical music that enhances the overall atmosphere of the film. The music that colors the story is part of the overall appeal of the film, and the classical music element is particularly memorable. In addition, the story depicts the adventures, affection, and friendship that Pinocchio and his friends have with a variety of animals, and will provide a fun time for animal lovers. This work A is one of the most famous films that has been enjoyed by audiences of all ages, from children to adults. If you are interested in fantasy, adventure, music, and animals, you should check out the work A.”

Further, if the large language model 742 is trained by the work information stored in the work information section 743, the SNS information stored in the SNS storage section 744, and the work evaluation information stored in the review storage section 745 (for example, trained by the information of “30s, male, recommended to watch with family” and “30s, male, found it different from when he was a child”, which are extracted from the SNS information on the basis of the parameters of “30s” and “male” included in the customer information), the controller 700 generates attractive work introduction information that will attract the interest of a customer by reflecting the customer information and the learning results of the large language model 742, such as “The work A is one of the most special animated films and can be recommended to enjoy with family or friends. The work A is a magical story about a doll born from a tree that magically transforms into a real-life boy. The film is a bit different from science fiction, but as it depicts adventures in a fantasy world, science fiction lovers may also enjoy the fantastical world. It also includes classical music that enhances the overall atmosphere of the film. The music that colors the story is part of the overall appeal of the film, and the classical music element is particularly memorable. In addition, the story depicts the adventures, affection, and friendship that Pinocchio and his friends have with a variety of animals, and will provide a fun time for animal lovers. In addition, although this work is based on a fairy tale, you will be able to enjoy it from a different perspective than when you saw it as a child, and new discoveries will await you. You should enjoy the work A.”

Next, the controller 700 stores the generated work introduction information in the work introduction information section 732 (S74). The controller 700 then transmits the work introduction information stored in the work introduction information section 732 to the prompt generator 5 (S75). The controller 700 then returns to S61.

As described above, the prompt generator 5 of the embodiment includes: the reception means 501 for receiving viewing request information including a customer ID for identifying a customer and work identification information for identifying a work to be viewed; the customer information acquisition means 502 for acquiring customer information related to the customer ID on the basis of the received customer ID; the customization means 503 for customizing the prompt information for requesting generation of work introduction information related to the work to make the prompt information suitable for the customer on the basis of the received viewing request information and the acquired customer information; and the provision means 504 for providing the customized prompt information to the large language model.

According to the prompt generator 5 in this embodiment, the customization means 503 customizes the prompt information on the basis of the viewing request information received by the reception means 501 and the customer information acquired by the customer information acquisition means 502, and the provision means 504 provides the customized prompt information to the processing server 7, so that it is possible to obtain work introduction information that fully reflects the preferences and interests of individual customers in response to work introduction requests.

Note that, for example, in the embodiment, the rental store that rents media has been described as an example, and the prompt generator 5 installed in the rental store as an example of a work introduction information generation support device, but the invention is not limited thereto. For example, the rental store may be a media store, bookstore, art store, library, movie theater, museum, art gallery, etc. instead, and the work introduction information generation support device may be a device installed in those facilities.

Further, in the embodiment, the prompt generator 5 has been described as an example of the work introduction information generation support device, but the invention is not limited thereto. For example, an application may be installed on the portable terminal 1, thus providing the configuration described in claims 1 to 7. In this case, the portable terminal 1 is the work introduction information generation support device. In this case, the output means 506 outputs (displays) the work introduction information received from the processing server 7 to the display device 18.

Further, in the embodiment, the portable terminal 1 has been described as an example of an interface, but the invention is not limited thereto. The interface may be a dedicated terminal that is installed in, for example, a rental store, bookstore, media store, bookstore, library, movie theater, museum, art gallery, etc., that can create and transmit viewing request information, and that can also show work introduction information.

Furthermore, in the embodiment, the large language model 742 has been trained by collecting three types of information, i.e., work information, SNS information, and work introduction information, but any one or two or more of those pieces of information may be used. It is also possible to train the large language model 742 on the basis of other types of information.

Furthermore, in the embodiment, the work information collection section Dc has been described as a device outside the prompt generator 5, but the work information collection section Dc may be an internal function of the prompt generator 5.

Note that the program to be executed by the prompt generator 5 of the embodiment is provided by being recorded in an installable or executable format file on non-transitory computer-readable recording media such as a CD-ROM, a flexible disk (FD), a CD-R, and a digital versatile disc (DVD).

Further, the program to be executed by the prompt generator 5 of the embodiment may be stored on a computer connected to a network such as the Internet and may be configured to be provided by having the program downloaded via the network. The program to be executed by the prompt generator 5 of the embodiment may also be configured to be provided or distributed via a network such as the Internet.

Furthermore, the program to be executed by the prompt generator 5 of the embodiment may be configured to be provided by being pre-embedded in a ROM or the like.

Furthermore, each function of the embodiment can be achieved by one or more processing circuits. Here, the “processing circuit” in this specification includes: a processor programmed to perform each function by software, such as a processor implemented by an electronic circuit; an application specific integrated circuit (ASIC), a digital signal processor (DSP), and a field programmable gate array (FPGA) designed to perform the functions described above; and devices such as conventional circuit modules.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A work introduction information generation support device, comprising:
a communication device that communicates with a customer interface and a customer server, and inputs viewing request information of a work from the customer interface and inputs customer information from the customer server, the viewing request information including customer identification information for identifying a customer and work identification information for identifying a work to be viewed, the customer server storing the customer information in association with the customer identification information, the customer information being information of the customer identified by the customer identification information;
a memory that stores a program for supporting generation of work introduction information related to the work; and
a processor configured to, by executing the program,
receive the viewing request information input by the communication device,
acquire the customer information input by the communication device on a basis of the customer identification information included in the received viewing request information,
customize prompt information for requesting the generation of the work introduction information to make the prompt information suitable for the customer on a basis of the received viewing request information and the acquired customer information, and
provide the customized prompt information to a large language model.

2. The work introduction information generation support device according to claim 1, wherein
the customer information includes viewing history information related to a plurality of types of works previously viewed by the customer, and
the processor customizes the prompt information by using the viewing history information.

3. The work introduction information generation support device according to claim 2, wherein
the customer information includes information related to a plurality of types of works preferred by the customer, and
the processor customizes the prompt information by using the information related to the plurality of types of works preferred by the customer.

4. The work introduction information generation support device according to claim 3, wherein
the customer information includes information of another work that appears in the plurality of types of works previously viewed by the customer, and
the processor customizes the prompt information by using the information of the other work.

5. The work introduction information generation support device according to claim 1, wherein
the processor further acquires the work introduction information generated by the large language model on a basis of the prompt information provided to the large language model.

6. The work introduction information generation support device according to claim 5, wherein
the processor transmits the acquired work introduction information to the customer interface via the communication device, as a response to the viewing request information from the customer interface.

7. The work introduction information generation support device according to claim 1, further comprising
a storage device that stores the prompt information of the work identified by the work identification information in association with the work identification information, wherein
the processor calls, from the storage device, prompt information related to the work identified by the work identification information included in the viewing request information on a basis of the received viewing request information.

8. The work introduction information generation support device according to claim 7, wherein
the processor customizes the called prompt information to make the prompt information suitable for the customer by reflecting the acquired customer information in the called prompt information.

9. The work introduction information generation support device according to claim 1, wherein
the communication device communicates with a processing server that stores the large language model, and
the large language model is a program that generates the work introduction information of the work, the work introduction information reflecting the customer information included in the customized prompt information provided via the communication device.

10. A control method for a work introduction information generation support device, the method comprising:
receiving viewing request information input by a communication device, the viewing request information including customer identification information for identifying a customer and work identification information for identifying a work to be viewed;
acquiring customer information input by the communication device on a basis of the customer identification information included in the received viewing request information;
customizing prompt information for requesting generation of work introduction information to make the prompt information suitable for the customer on a basis of the received viewing request information and the acquired customer information; and
providing the customized prompt information to a large language model.
